(19) United States
(12) Patent Application Publication
(10) Pub. No.: US 2006/0193991 A1
(43) Pub. Date: Aug. 31, 2006

(54) Sealer coating composition and method for forming a removable barrier layer on porous surfaces

(76) Inventor: Andre V. Ghosoph, Clovis, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/364,528

(22) Filed: Feb. 27, 2006

Related U.S. Application Data
(60) Provisional application No. 60/657,767, filed on Feb. 28, 2005.

(51) Int. Cl. B05D 1/02

(52) U.S. Cl. 427/421.1; 524/80; 427/355

(57) ABSTRACT

A sealer coating composition comprising a mixture of toluene and polystyrene that is used to form a removable barrier layer on the surface of a porous material so as to prevent calcium, mineral, oil, water, dirt or other deposits from accumulating on or adhering to the porous material. Any such deposits will attach to the barrier layer instead of the porous material. The deposits can be removed by applying toluene to remove both the barrier layer and the deposits, thereby reducing the time, cost and difficulty associated with cleaning the porous material. The barrier layer is then reapplied to the surface of the porous material. The sealer coating is particularly beneficial for protecting tile or other porous materials utilized at the waterline of a pool, spa or other swimming area. The sealer coating can also protect marble, stone, pebble, masonry and like materials.

### CROSS-REFERENCE TO RELATED APPLICATIONS

This application claims the benefit of U.S. Provisional Application No. 60/657,767 filed on Feb. 28, 2005.

### BACKGROUND OF THE INVENTION

A. Field of the Invention

The field of the present invention relates generally to chemical compositions utilized to facilitate the removal of calcium, mineral, oil water, dirt and other deposits from porous surfaces, including tile, marble, stone, pebble and masonry surfaces. In particular, the present invention relates to such chemical compositions that are applied to a porous surface to form a barrier layer that prevents deposits from sticking to and building-up on the porous surface. Even more particularly, this invention relates to such compositions that are configured so the user can remove the barrier layer and deposits collected thereon and reapply a fresh coating layer to the porous surface.

B. Background

Decorative and functional surfaces are often made up of one or more types of porous materials, including tile, marble, stone, pebble and masonry. As is well known, a major purpose for use of these materials is to provide a particular aesthetic appeal to the area in which the material is used. As an example, pools, spas and hot tubs often use a layer of tile at and above the waterline. In addition, the area around the pool, spa or hot tub may be covered with stone, masonry or other porous materials. Unfortunately, minerals in the water and elsewhere are known to accumulate on these generally porous materials. With regard to the types of tile commonly used in pools, spas and hot tubs, for instance, evaporation and the lapping of water against the sides of the enclosure often results in a build-up of calcium and other mineral deposits on the tile. Naturally, the build-up of mineral deposits on the tile or other generally porous surfaces around or near the pool, spa or hot tub diminishes the aesthetic qualities of the material used for these surfaces and reduces the owner's enjoyment of the pool, spa or hot tub. Likewise, the build-up of salt crystals on a surface caused by the evaporation of salt-laden water, referred to as efflorescence, is also unappealing.

Due to the porous nature of tile, marble, stone, pebble, masonry and similar surface materials, removing the accumulated mineral or other deposits from these materials can be somewhat difficult. As an example, the traditional methods of cleaning pool tile to remove deposits accumulated thereon typically involve manually removing the deposits through the application of significant effort by the pool owner or the owner's pool maintenance person. One such method is the use of a soft pumice stone or stiff brush that is rubbed against the affected tile until the deposits are substantially removed. Another method of removing deposits involves the application of chemicals which are selected to react with the deposits so as to remove the deposits from the tile or other porous surface. With regard to any such method of removing deposits, the manual removal device (i.e., pumice stone or brush) or chemical(s) selected for the task must be chosen carefully such that their use does not damage the surface material. In addition, care must be used not to cause injury to the person through the misuse of the removal device or chemical.

A more modern method of solving the problem of calcium, mineral, oil, water, dirt or other deposits on generally porous materials, particularly pool tiles and the like, is to coat the material's surface with a chemical composition that provides a physical barrier between the surface of the material and the deposits that accumulate thereon. One example of such a barrier system approach is the TPS Protectant and Restorative™ compound available from Coating Systems Laboratories, Inc. out of Chandler, Ariz. The product is a silicon-based polymer that is configured to provide a generally transparent barrier to prevent the build-up of scale and minerals on the surface material. Another barrier product is S-B-S Sealer™ by Aldon Corporation out of Reno, Nev. This product comprises an acrylic in a solvent base. Yet another product is Tile Guard™, which contains a methyl isobutyl ketone compound that provides the chemical barrier against scale and mineral build-up. One of the disadvantages of the aforementioned and other existing chemical barrier products is the removal of the barrier layer when it is desired or necessary to remove the build-up of scale and minerals thereon and then reapply a new barrier layer to the porous surface. Some barrier systems require removal by sandblasting (or an equivalent method) or the use of a lacquer/thinner material for effective removal. The requirement for removal by these methods has somewhat diminished the acceptance and popularity of these barrier systems.

What is needed is an improved sealer coating compound that forms a chemical barrier to prevent the accumulation or build-up of calcium, mineral, oil, water, dirt or other deposits directly on porous surface materials, such as those used for pool tile, pool decks, areas around spas and hot tubs, driveways, patios and the like. The preferred sealer coating should form an effective barrier layer that protects the porous material from the build-up of deposits on the surface of the material. The preferred sealer coating should be selected for relatively easy removal of the barrier layer and any calcium/mineral or other deposits thereon so the user can periodically remove such barrier layer and deposits and place a new barrier layer on the surface of the porous material to protect the material against future build-up of deposits.

### SUMMARY OF THE INVENTION

The improved sealer coating for porous materials of the present invention provides the benefits and solves the problems identified above. That is to say, the present invention discloses a sealer coating which forms an effective chemical barrier to prevent the build-up of calcium, mineral, oil, water, dirt and/or other deposits directly on the surface of the porous material. In addition, the sealer coating of the present invention provides a chemical barrier that is relatively easy to remove so the user can clean the deposits off of the porous material without an undue amount of difficulty and place a new or fresh barrier layer on its surface to protect the porous material from future build-up of deposits. The sealer coating of the present invention is relatively easy and inexpensive to make and adaptable for use on a wide variety of different types of porous materials, including those commonly utilized for pool tiles, pool decks, carports, driveways, patios and the like.

In one general aspect of the present invention, the sealer coating composition for forming a removable barrier layer on the surface of a porous material, such as tile and the like, comprises a quantity of toluene mixed with a quantity of polystyrene. In the preferred embodiment, the composition is mixed with a ratio of approximately one gallon of toluene to approximately one pound of polystyrene to form the sealer coating composition into the consistency of a liquid-plastic mixture that is suitable for spreading onto the surface of the porous material. In another embodiment, the composition is provided in a consistency suitable for spraying onto the porous material with an airless sprayer, spray bottles or similar mechanisms. The polystyrene can be supplied in granular form, such as the generally spherical granules utilized in injection molding processes. The toluene and polystyrene are added to a container, such as a bucket, allowed to sit while the toluene initially dissolves the polystyrene, stirred to more thoroughly mix the two materials together and then allowed to sit again for further dissolving of the polystyrene. In the preferred embodiment, the sealer coating composition of the present invention is applied by spreading the composition on the surface of a porous material to form a barrier layer that prevents deposits, such as calcium and the like, from building-up on or adhering to the surface of the porous material. Instead of sticking to the porous material, the deposits will stick to the barrier layer. The deposits can be relatively easily, quickly and inexpensively removed by applying pure toluene to the surface of the porous material, thereby removing both the barrier layer and the deposits. The barrier layer is then reapplied to prevent future build-up of deposits.

Accordingly, the primary objective of the present invention is to provide an improved sealer coating composition and method for forming a removable barrier layer on porous surfaces that provides the benefits described above and overcomes the disadvantages and limitations which are associated with presently available barrier layer sealer coatings.

An important objective of the present invention to provide a sealer coating composition and method that is suitable for effectively protecting porous surfaces from the accumulation of calcium, mineral, oil, water, dirt or other deposits by providing a barrier layer between the surface and any such deposits.

It is also an important objective of the present invention to provide a sealer coating composition and method for porous surfaces that is configured for relatively easy removal of the barrier layer, as well as any deposits accumulated thereon, so the user can place a new or fresh barrier layer on the surface material.

It is also an important objective of the present invention to provide a sealer coating composition and method for porous surfaces that comprises a mixture of toluene and polystyrene in a ratio of approximately one gallon of toluene to approximately one pound of polystyrene that forms a barrier layer on the porous material which can be removed, along with any deposits accumulating thereon, by the application of pure toluene.

The above and other objectives of the present invention will be explained in greater detail by reference to the attached figure and the description of the preferred embodiment which follows. As set forth herein, the present invention resides in the novel features of the combination of chemicals, form, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is an exploded perspective view illustrating a porous material having a barrier layer comprised of the sealer coating composition of the present invention thereon to separate the surface of the material from the build-up of calcium, mineral, oil, water, dirt or other deposits; and

FIG. 2 is a perspective view of the container shown receiving the approximate ratios of toluene and polystyrene to form the sealer coating composition of the present invention.

### DETAILED DESCRIPTION OF THE PREFERRED EMBODIMENTS

With reference to the included figures, the preferred embodiments of the present invention are set forth below. The enclosed figures are merely illustrative of a preferred embodiment and represents one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For purposes of simplifying this disclosure, the discussion and references herein are generally to use of the present invention with regard to protecting pool tile and the like. Those skilled in the art will readily understand and appreciate, however, that the sealer coating composition and method disclosed herein is not so limited, namely that it can be used to provide an effective barrier against the build-up of scale and mineral deposits on other types of surface materials, particularly such generally porous materials as marble, stone, pebble and masonry.

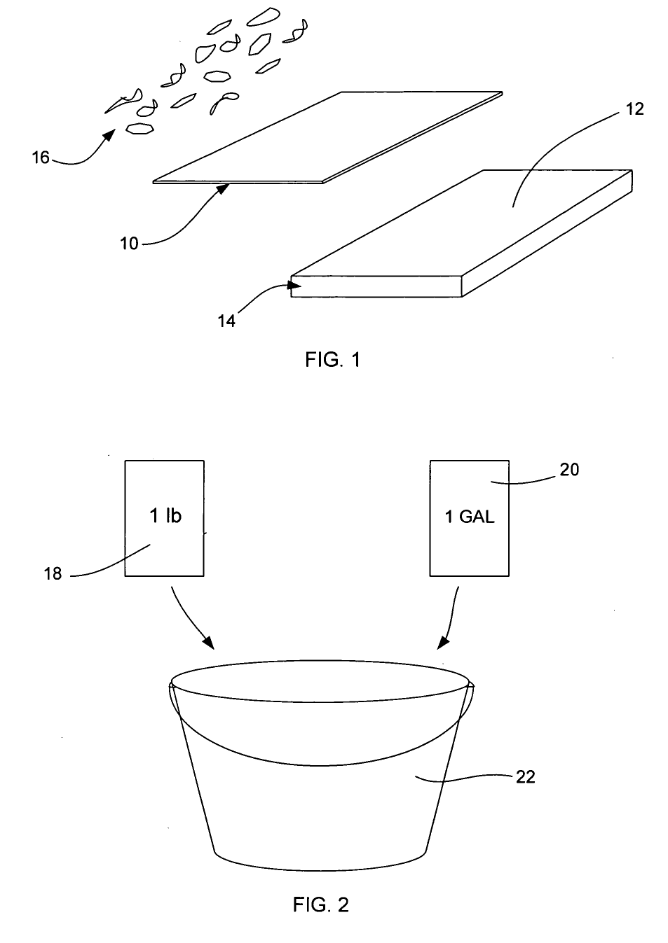

A barrier layer formed by the sealer coating that is manufactured out of the components and configured pursuant to a preferred embodiment of the present invention is shown generally as 10 in the figures. As shown in FIG. 1, the surface 12 of porous material 14 is coated with the sealer coating composition of the present invention to form barrier layer 10 to prevent the build-up and attachment of calcium, mineral, oil, water, dirt or other deposits, hereinafter referred to generally as “deposits” and shown as 16, on the surface 12 of porous material 14. As desired by those skilled in the art, sealer coating composition of the present invention is configured to provide a barrier layer 10 that prevents the deposits from adhering or sticking directly to the surface 12 of porous material 14 so as to reduce the amount of time, effort and cost of removing deposits 16 therefrom. Those skilled in the art will readily recognize that the sealer coating composition of the present invention does not prevent the build-up of deposits 16, but instead is adapted and configured to provide a protective barrier layer 10 that is more conducive to removing the accumulated deposits 16 with a reasonable amount of effort. As such, barrier layer 10 is somewhat of a sacrificial layer that is removed with the removal of the deposits 16.

The preferred sealer coating composition of the present invention comprises a mixture of toluene and polystyrene that forms a compound which is placed directly on the surface 12 of porous material 14 to form barrier layer 10 thereon. The preferred composition is mixed in a ratio of approximately (i.e., plus or minus 10%) one pound of polystyrene resin, shown as 18, to approximately (i.e., plus or minus 10%) one gallon of toluene, shown as 20. In one preferred embodiment of the sealer coating composition, the polystyrene is of the granular type, such as the spherical granules that are utilized in injection molding machines and processes. Because polystyrene is a hard plastic that will not absorb any appreciable amount of water, it forms an effective coating and barrier layer 10 for surface 12 of porous material 14. In one configuration, as an example and shown in FIG. 2, a quantity of the sealer coating composition of the present invention is made by placing approximately one pound of polystyrene resin 18 into a container, such as a bucket 22, and then adding approximately one gallon of toluene 20 to the bucket 22 to form a mixture of polystyrene and toluene. After allowing a sufficient amount of time for the toluene to initially dissolve a portion of the polystyrene, the mixture is stirred to more evenly mix the two materials together and then the stirred mixture is left to sit for further dissolving of the polystyrene. The polystyrene initially dissolves in the toluene to form a jelly-like mass in container 22. Stirring of the mixture results in a composition having a liquid-plastic consistency suitable for spreading to form barrier layer 10 on the surface 12 of porous material 14. If desired, additional toluene can be added to the mixture to provide a thinner, more easily spread product. In general, a thinner composition is better due to the ease of application and less likelihood of shrinkage, pealing and burning issues. Other volumes of the sealer coating composition of the present invention can be manufactured using the approximate one gallon to one pound ratio set forth above.

In use, the sealer coating composition is manufactured as described above and then is applied on surface 12 of porous material 14 to form the barrier layer 10 that will protect porous material 14 from the build-up of calcium, mineral, oil, water, dirt or other deposits 16. When applied to surface 12 of porous material 14, the barrier layer 10 formed by the sealer coating composition of the present invention will be generally impervious to water and most other non-solvent liquids, resulting in the build-up of deposits 16 on the barrier layer 10 instead of the surface 12 of porous material 14. The sealer coating composition can be applied to the surface 12 of porous material 14 by spreading with a clean, lint free cloth. Alternatively, if the consistency of the sealer coating composition is appropriately configured, such as by adding more toluene, the composition can be applied by spraying with an airless sprayer, by spray bottles or by other mechanisms well known in the art. The surface 12 of porous material 14 being treated with the sealer coating composition of the present invention should be substantially dry when the barrier layer 10 is formed. Once applied, the barrier layer 10 will provide the desired “wet look” having a smooth finish that water will bead off. When it is desired or necessary to remove barrier layer 10, and any deposits 16 accumulated thereon, the user wipes an area of surface 12 of porous material 12 with a cloth having a quantity of pure toluene thereon. The barrier layer 10 is easily removed by the application, preferably by spreading, of the pure toluene to expose the surface 12 of porous material 14 so that it can then be re-coated with the sealer coating composition of the present invention to provide a new barrier layer 10. This ability to relatively easily, quickly and inexpensively remove the barrier layer 10, and deposits 16 that are accumulated thereon, is one of the features that distinguishes the present invention from previously and currently available sealant coatings.

While there are shown and described herein a specific form of the invention, it will be readily apparent to those skilled in the art that the invention is not so limited, but is susceptible to various modifications and rearrangements in materials and processes without departing from the spirit and scope of the invention. In particular, there are various chemical components described herein that can be replaced with equivalent functioning components to accomplish the objectives of the present invention.

What is claimed is:

1. A sealer coating composition for forming a removable barrier layer on a surface of a porous material, said sealer coating comprising a quantity of toluene mixed with a quantity of polystyrene, wherein said composition is mixed to a consistency suitable for application to said surface.

2. The sealer coating composition of claim 1, wherein said composition is mixed in a ratio of said quantity of toluene to said quantity of polystyrene being approximately one gallon of toluene to approximately one pound of polystyrene.

3. The sealer coating composition of claim 1, wherein said consistency is liquid-plastic.

4. The sealer coating composition of claim 3, wherein said consistency is suitable for spreading said composition on said surface.

5. The sealer coating composition of claim 1, wherein said quantity of polystyrene is granular.

6. The sealer coating composition of claim 1, wherein said barrier layer is generally impervious to water.

7. A method of forming a barrier layer on a surface of a porous material, said method comprising the steps of:
a. mixing a quantity of toluene and a quantity of polystyrene together to provide a sealer coating composition; and
b. applying said sealer coating composition to said surface to form said barrier layer.

8. The method of claim 7, wherein said composition is mixed in a ratio of said quantity of toluene to said quantity of polystyrene being approximately one gallon of toluene to approximately one pound of polystyrene.

9. The method of claim 7, wherein said quantity of toluene is approximately one gallon and said quantity of polystyrene is approximately one pound.

10. The method of claim 7, wherein said applying step is by spreading.

11. The method of claim 7, wherein said applying step is by spraying.

12. The method of claim 7 further comprising the step of removing said barrier layer by applying toluene to said barrier layer.

13. The method of claim 12, wherein said toluene is applied by spreading.

14. A method of manufacturing a sealer coating composition, said method comprising the steps of:
a. placing a quantity of polystyrene into a container;
b. adding a quantity of toluene to said quantity of polystyrene to form a mixture of polystyrene and toluene;
c. allowing said mixture to at least partially dissolve;
d. stirring said mixture to mix said quantity of polystyrene and said quantity of toluene into a stirred mixture; and
e. allowing said stirred mixture to further dissolve into a desired consistency.

15. The method of claim 14, wherein said composition is mixed in a ratio of said quantity of toluene to said quantity of polystyrene being approximately one gallon of toluene to approximately one pound of polystyrene.

16. The method of claim 14, wherein said consistency is liquid-plastic.

17. The method of claim 16, wherein said consistency is suitable for spreading said composition on a surface of a porous material to form a barrier layer thereon.

18. The method of claim 14, wherein said quantity of polystyrene is granular.
